(19) United States
(12) Patent Application Publication
(10) Pub. No.: US 2024/0218978 A1
(43) Pub. Date: Jul. 4, 2024

(54) FLOATING STRUCTURE COMPRISING A SYSTEM FOR SUPPLYING A CONSUMER WITH A FUEL PREPARED FROM LIQUEFIED NATURAL GAS OR A MIXTURE OF METHANE AND AN ALKANE COMPRISING AT LEAST TWO CARBON ATOMS

(71) Applicant: GAZTRANSPORT ET TECHNIGAZ, Saint Remy Les Chevreuse (FR)

(72) Inventors: Pavel BORISEVICH, Saint Remy Les Chevreuse (FR); Ezequiel ORLANDI, Saint Remy Les Chevreuse (FR)

(73) Assignee: GAZTRANSPORT ET TECHNIGAZ, Saint Remy Les Chevreuse (FR)

(21) Appl. No.: 18/558,237

(22) PCT Filed: Apr. 15, 2022
(86) PCT No.: PCT/FR2022/050722

§ 371 Date: Oct. 31, 2023

(30) Foreign Application Priority Data
May 7, 2021 (FR) 2104879

(51) Int. Cl. F17C 9/04; B63B 25/16; B63B 27/34

(52) U.S. Cl. CPC F17C 9/04; B63B 25/16; B63B 27/34; F17C 2221/033; F17C 2227/0339; F17C 2260/035; F17C 2265/031; F17C 2265/034; F17C 2265/066; F17C 2270/0105

(57) ABSTRACT

A floating or onshore structure includes at least one tank in which is contained liquefied natural gas or a mixture of liquid methane and an alkane comprising at least two carbon atoms and being in the liquid state, at least one consumer, and at least one supply system for supplying a fuel to the consumer in a first configuration, the fuel being prepared from a gas resulting from the boil-off of the liquefied natural gas contained in the tank, and for supplying the fuel to the consumer in a second configuration, the fuel being prepared from a gas resulting from the boil-off of the mixture contained in the tank.

The present invention relates to the field of the transport and/or storage of a cryogenic liquid. The invention relates more particularly to a floating or onshore structure whereof at least one consumer is supplied with at least one fuel prepared from the boil-off of part of the cryogenic liquid stored and/or transported in at least one tank of the structure.

Gaseous hydrocarbons at room temperature and atmospheric pressure are liquefied at cryogenic temperatures, i.e. temperatures below −60° C., in order to facilitate their transport and/or storage. The hydrocarbons thus liquefied, also called cryogenic liquids, are then placed in tanks of a floating or onshore structure.

However, such tanks are never perfectly thermally insulated so that boil-off of the cryogenic liquid is inevitable. The phenomenon of natural evaporation is called boil-off, and the gas resulting from this natural evaporation is called boil-off gas (BOG). The tanks of the structure thus comprise both the cryogenic liquid in liquid form and the gas resulting from the boil-off of the cryogenic liquid in liquid form.

Part of the gas resulting from the boil-off of the cryogenic liquid in liquid form may be used as fuel to supply at least one consumer, such as an engine, provided to meet the operating energy needs of the floating or onshore structure. Thus, it is possible to generate electricity for electrical equipment.

The consumer is generally adapted to a particular type of cryogenic liquid that is transported and/or stored in the tanks of the structure. Thus, when another type of cryogenic liquid is transported and/or stored in the structure, the gas resulting from boil-off may not be usable as fuel to supply the consumer. It is therefore customary to dedicate the structure to a specific type of cryogenic liquid.

An object of the invention is to provide a structure on which several types of cryogenic liquids are stored and/or transported, at the same time or alternately, and can be treated to supply fuel to at least one consumer of the structure.

The present invention proposes a floating or onshore structure comprising at least one tank in which is contained liquefied natural gas or a mixture of liquid methane and an alkane comprising at least two carbon atoms and being in the liquid state, at least one consumer, at least one supply system for supplying a fuel to the consumer in a first configuration, the fuel being prepared from a gas resulting from the boil-off of the liquefied natural gas contained in the tank, and for supplying the fuel to the consumer in a second configuration, the fuel being prepared from a gas resulting from the boil-off of the mixture contained in the tank, the supply system comprising a conversion device configured to alternate between the first configuration and the second configuration of the supply system, the supply system comprising a heat exchange module configured to at least partially liquefy the gas resulting from the boil-off of the mixture contained in the tank and a fuel preparation system from the at least partly liquefied gas, the fuel prepared from the at least partly liquefied gas having a methane number greater than a methane number of the mixture.

The methane index is the measure of the mechanical resistance to impacts in an engine generated during the combustion of gases; this is also referred to as engine knocking. It is assigned to a test fuel based on operation in a knock test unit at the same standard knock intensity. Pure methane is designated as the reference fuel with a methane number of 100. Pure dihydrogen is also used as a knock-sensitive reference fuel with a methane number of 0.

The structure may therefore be required to store and/or transport a first cryogenic liquid and a second cryogenic liquid alternately. Depending on the cryogenic liquid stored and/or transported in one or more tanks of the structure, a supply system of the structure is configured to supply a fuel to a consumer of the structure. The fuel is prepared from the stored and/or transported cryogenic liquid. When the first cryogenic liquid and the second cryogenic liquid are of different natures, a first configuration of the supply system makes it possible to prepare the fuel from the first cryogenic liquid and a second configuration of the supply system makes it possible to prepare the fuel from the second cryogenic liquid. The change in configuration of the supply system is done by the conversion device.

More specifically, the gas resulting from the boil-off of the second cryogenic liquid, which is the mixture of liquid methane and an alkane comprising at least two carbon atoms and being in the liquid state, successively passes through the heat exchange module and the fuel preparation system so as to obtain a fuel having a methane number higher than a methane number of the mixture and thus usable by the consumer.

According to one embodiment, the alkane is chosen from ethane, propane, butane and at least one mixture thereof. It should be understood here, as well as in all that follows, that “butane” designates n-butane and isobutane, which is also called 2-methylpropane.

According to one embodiment, a methane number of the mixture is less than 70.

According to one embodiment, the fuel preparation system comprises at least one gas outlet connected to the consumer to deliver the fuel, a supply branch configured to supply at least a portion of the gas resulting from the boil-off of the mixture from the tank to an inlet of the preparation system, and in which the heat exchange module comprises at least one thermal heat exchanger comprising a first pass constituting the supply branch and arranged between a gas inlet of the supply system and the inlet of the preparation system, a cooling branch configured to be passed through by the liquefied natural gas or the mixture, the cooling branch comprising a second pass of the thermal heat exchanger, the second pass of the thermal heat exchanger being configured to exchange calories with the first pass of the thermal heat exchanger in order to at least partially liquefy the gas circulating in the first pass of the thermal heat exchanger.

According to one embodiment, the heat exchange module comprises at least one heat exchanger comprising a first pass constituting the supply branch and disposed between the gas inlet of the supply system and an inlet of the first pass of the thermal heat exchanger, said gas inlet being connected to a gas outlet of the tank, the heat exchanger comprising a second pass constituting the supply branch and connected to the first pass by a connecting portion of the supply branch, the connecting portion comprising at least one compression device.

According to one embodiment, the heat exchange module comprises a calorie exchanger comprising a first pass constituting the supply branch and arranged between an outlet of the second pass of the heat exchanger and an inlet of the first pass of the thermal heat exchanger, the calorie exchanger comprising a second pass constituting a sampling branch that is configured to supply at least a portion of the liquefied natural gas, in particular the liquid phase of the liquefied natural gas, or of the mixture, in particular the liquid phase of the mixture, from a tank to a fuel inlet of a propulsion device of the structure, the first pass of the calorie exchanger being configured to exchange calories with the second pass of the calorie exchanger. The first pass of the thermal heat exchanger can thus be arranged between an outlet of the second pass of the heat exchanger and the inlet of the preparation system.

According to one embodiment, the supply system comprises a bypass branch of the first pass of the heat exchanger, the bypass branch connecting an inlet of the first pass of the heat exchanger and an outlet of the first pass of the heat exchanger. The bypass branch is thus mounted in parallel with the first pass of the heat exchanger. When a cryogenic liquid flows through the supply system, it is possible to pass the flow through the first pass of the heat exchanger or through the bypass branch.

According to one embodiment, the supply system comprises a bypass branch of the second pass of the thermal heat exchanger, the bypass branch connecting an inlet of the second pass of the thermal heat exchanger to an outlet of the second pass of the thermal heat exchanger. The bypass branch is thus mounted in parallel with the second pass of the thermal heat exchanger. When cryogenic liquid flows through the supply system, it is possible to pass the flow through the second pass of the thermal heat exchanger or through the bypass branch.

According to one embodiment, the supply system comprises a bypass branch of at least the preparation system, the bypass branch being disposed between an outlet of the compression device and a gas outlet of the preparation system. Thus, it is possible to avoid the preparation system, if fuel preparation does not require the preparation system.

According to one embodiment, the supply system comprises a fuel heater-cooler arranged between the gas outlet of the preparation system and a gas outlet of the supply system connected to a fuel inlet of the consumer. The fuel is thus at an optimum temperature for use by the consumer.

According to one embodiment, the supply system comprises a conversion device configured to alternate between the first configuration and the second configuration of the supply system.

According to one embodiment, the conversion device comprises a plurality of regulation devices disposed at least in part in the supply branch, the plurality of regulation devices comprising a first regulation device arranged to control the flow of gas in the first pass of the heat exchanger or in the bypass branch.

According to one embodiment, the conversion device comprises a plurality of regulation devices arranged at least in part in the cooling branch, the plurality of regulation devices comprising at least a second regulation device arranged to control the circulation of liquid in the second pass of the thermal heat exchanger or into the bypass branch. In addition or alternatively, the second regulation device may also be arranged to control the circulation of liquid in a connection channel of the supply system. The connection channel connects the inlet of the second pass of the thermal heat exchanger to a connection point of the cooling branch. The connection point is arranged on the cooling branch between the second control device of the distribution device and the spraying device.

According to one embodiment, the conversion device comprises a plurality of regulation devices arranged at least in part in the bypass branch and/or in the supply branch, the plurality of regulation devices comprising a third regulation device arranged to control the circulation of the liquid in the second pass of the heat exchanger or in the bypass branch.

According to one embodiment, the preparation system comprises a first phase separator, a second phase separator and an expansion device disposed on a line connecting a liquid outlet of the first phase separator to an inlet of the second phase separator, an inlet of the first phase separator being connected, for example by means of a duct, to the heat exchange module, preferably to the outlet of the first pass of the thermal heat exchanger, at least one gas outlet of the first phase separator being connected to the consumer to deliver the fuel, the supply system being configured to place a liquid outlet of the second phase separator in fluidic communication, for example by means of a duct, with at least one tank. Thus, it is possible to use the by-products resulting from the preparation of the fuel.

According to one embodiment, a gas outlet of the second phase separator is connected to a junction point of the supply branch arranged between a gas outlet of the tank and an inlet of the compression device. The connection between the gas outlet of the second phase separator and the junction point can be made by a duct.

According to one embodiment, the cooling branch comprises a cooling device arranged between a liquid inlet of the supply system and an inlet of the second pass of the thermal heat exchanger to cool the liquefied natural gas and the mixture, alternatively. This makes it possible in particular to sub-cool the liquefied natural gas or the mixture and thus to improve the heat exchanges between the first pass and the second pass of the thermal heat exchanger, the mixture being composed of liquid methane and an alkane comprising at least two carbon atoms and being in the liquid state. Preferably, the alkane may be chosen from ethane, propane, butane and at least one mixture thereof

According to one embodiment, a flow of liquefied natural gas or of the mixture in the first pass of the thermal heat exchanger is oriented in a direction opposite a flow of liquefied natural gas or of the mixture in the second pass of the thermal heat exchanger. In other words, the flow of liquefied natural gas or of the mixture in the first pass of the thermal heat exchanger takes place countercurrent to the flow of liquefied natural gas or of the mixture in the second pass of the thermal heat exchanger.

According to one embodiment, a flow of liquefied natural gas or of the mixture in the first pass of the heat exchanger is oriented in a direction opposite a flow of liquefied natural gas or of the mixture in the second pass of the heat exchanger. In other words, the flow of liquefied natural gas or of the mixture in the first pass of the heat exchanger is countercurrent to the flow of liquefied natural gas or of the mixture in the second pass of the heat exchanger.

According to one embodiment, a flow of liquefied natural gas or of the mixture in the first pass of the calorie exchanger is oriented in the same direction as a flow of liquefied natural gas or of the mixture in the second pass of the calorie exchanger. In other words, the flow of liquefied natural gas or of the mixture in the first pass of the calorie exchanger is co-current with the flow of liquefied natural gas or of the mixture in the second pass of the calorie exchanger.

According to one embodiment, the supply system comprises a temperature control device configured to measure a temperature of the liquefied natural gas or of the mixture at the outlet of the second pass of the thermal heat exchanger and to adjust a circulation rate of the liquefied natural gas or of the mixture circulating in the cooling branch depending on the measured temperature.

According to one embodiment, the preparation system comprises a connection branch between a first connection point, arranged between an outlet of the compression device and the inlet of the first pass of the thermal heat exchanger, preferably the inlet of the second pass of the heat exchanger, and a second connection point arranged on a sampling branch configured to bring at least a portion of the liquid from the tank to a fuel inlet of a propulsion device, the compression device is configured to compress the natural gas or the mixture flowing therethrough to a pressure suitable for use by the consumer device, and the supply system comprises an expansion member arranged between the first connection point and the inlet of the first pass of the thermal heat exchanger so that the liquefied natural gas or the mixture has a pressure adapted to the preparation system at an outlet of the expansion member.

According to one embodiment, the preparation system comprises a connection branch between a first connection point, arranged between an outlet of the compression device and the inlet of the first pass of the thermal heat exchanger, preferably the inlet of the second pass of the heat exchanger, and a second connection point arranged on a sampling branch configured to bring at least a portion of the liquid from the tank to a fuel inlet of a propulsion device; the compression device comprises a first part arranged partly on the supply branch and a second part on the connection branch, the first connection point being arranged between the first part and the second part of the compression device, the compression device being configured so that the liquefied natural gas or the mixture has a pressure adapted to the preparation system at an outlet of the first part of the compression device that corresponds to the first connection point, and so that the fluid has a pressure adapted to be used by the consumer device at an outlet of the second part of the compression device that corresponds to the second connection point.

The invention also proposes a transfer system for a cryogenic liquid, the system comprising a structure having at least one of the preceding characteristics, insulated pipes arranged so as to connect the tank installed in the floating structure to a floating or onshore storage facility and a pump for driving a flow of cryogenic liquid through the insulated pipes from or to the floating or onshore storage facility to or from the tank of the structure.

The invention further offers a method for loading or unloading a structure having at least one of the preceding features, during which cryogenic liquid is conveyed through insulated pipes from or to a floating or onshore storage facility to or from the tank of the floating structure.

The invention proposes a method for preparing a fuel from a gas resulting from the boil-off of a cryogenic liquid comprising at least methane; preferably the cryogenic liquid is the mixture of liquid methane and the alkane comprising at least two carbon atoms and being in the liquid state, and stored in at least one tank, the fuel being prepared by a supply system of a structure, the structure having at least one of the preceding characteristics, the supply system being in a second configuration, during which the flow of the gas takes place at least in the supply branch by passing through the first pass of the thermal heat exchanger and then passing through the preparation system. The alkane may be chosen from ethane, propane, butane and at least one mixture thereof. More preferably, the mixture comprises at least liquid ethane and liquid methane.

According to one embodiment, the gas flow passes through the first pass of the heat exchanger and the second pass of the heat exchanger before passing through the first pass of the thermal heat exchanger.

The invention proposes a method for preparing a fuel from a gas resulting from the boil-off of a cryogenic liquid comprising at least methane; the cryogenic liquid is preferably liquefied natural gas, and stored in at least one tank, the fuel being prepared by a supply system of a structure, the structure having at least one of the preceding characteristics; the gas flow takes place at least in the supply branch by passing through the compression device and then passing into the bypass branch.

According to one embodiment, the flow of gas takes place by passing through the bypass branch before passing through the compression device.

Other features and advantages of the invention will appear both from the description which follows and from several exemplary embodiments, which are given for illustrative purposes and without limitation with reference to the appended schematic drawings, in which:

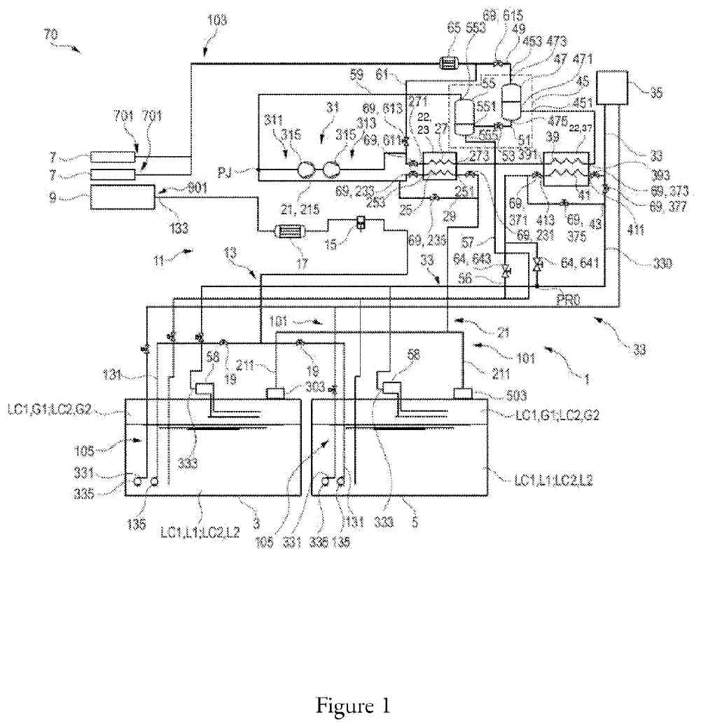

FIG. 1 is a schematic representation of a floating structure comprising a consumer supply system according to the invention in a first embodiment;

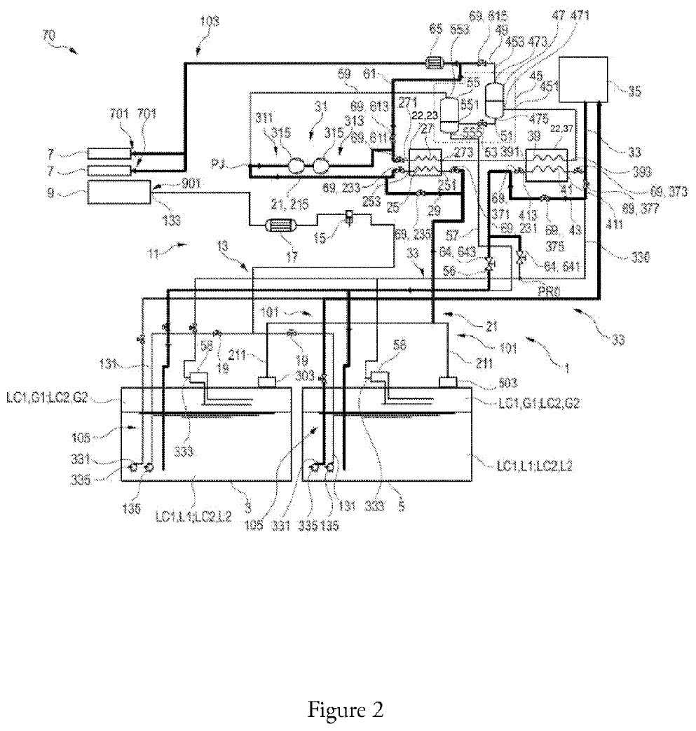

FIG. 2 is a schematic representation of the supply system of FIG. 1 in a first configuration;

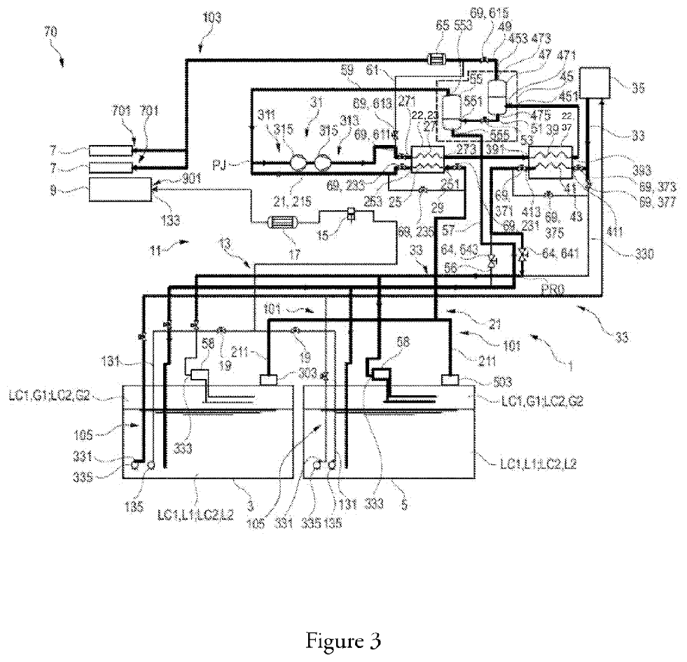

FIG. 3 is a schematic representation of the supply system of FIG. 1 in a second configuration;

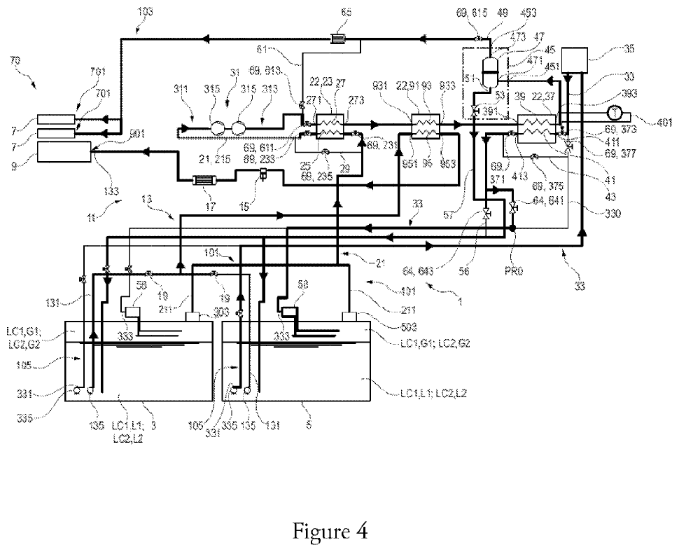

FIG. 4 is a schematic representation of a floating structure comprising a consumer supply system according to the invention in a second embodiment

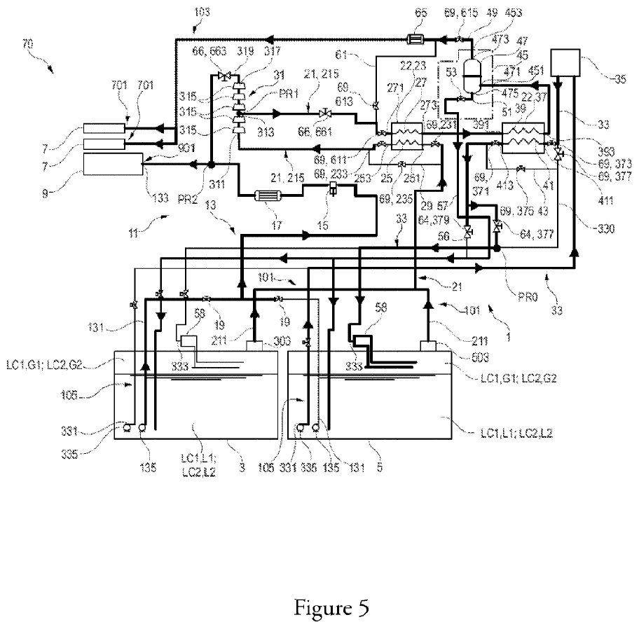

FIG. 5 is a schematic representation of a floating structure comprising a consumer supply system according to the invention in a third embodiment;

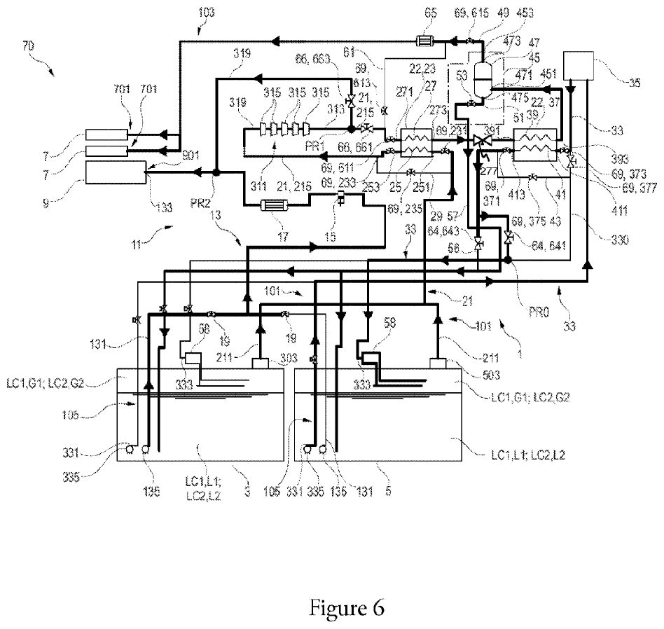

FIG. 6 is a schematic representation of a floating structure comprising a consumer supply system according to the invention in a fourth embodiment;

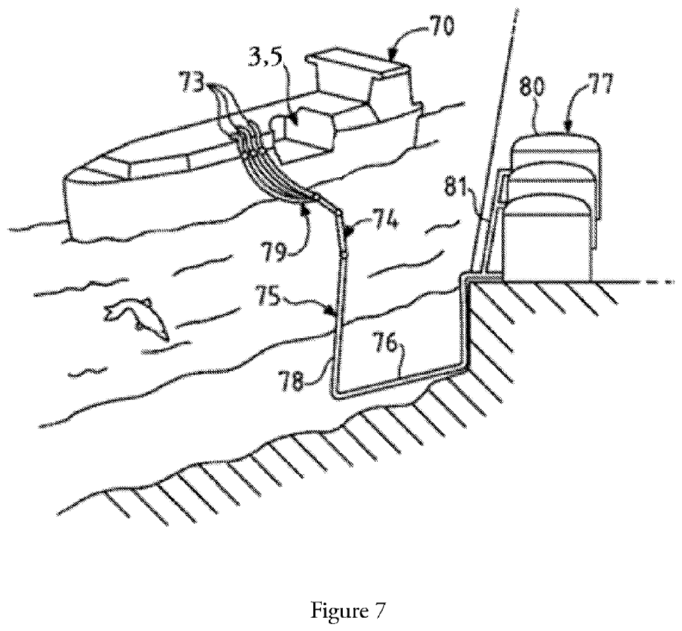

FIG. 7 is a cutaway schematic representation of the floating structure of FIG. 1 and a loading/unloading terminal for tanks of the floating structure.

It should first of all be noted that while the figures set out the invention in detail for its implementation, they may of course be used to better define the invention where appropriate. It should also be noted that, in all of the figures, similar elements and/or elements fulfilling the same function are indicated by the same numbering.

The invention relates to a floating or onshore structure, which is particular in that it comprises at least one tank in which is contained a first cryogenic liquid, preferably liquefied natural gas, or a second cryogenic liquid, preferably the mixture consisting of an alkane comprising at least two carbon atoms in the liquid state and liquid methane, at least one consumer, and which is particular in that it comprises at least one supply system for supplying a fuel to the consumer in a first configuration, the fuel being prepared from a gas resulting from the boil-off of the first cryogenic liquid contained in the tank, and for supplying the fuel to the consumer in a second configuration, the fuel being prepared from a gas resulting from the boil-off of the second cryogenic liquid contained in the tank.

The alkane comprising at least two carbon atoms may be chosen from ethane, propane, butane and at least one mixture thereof. More preferably, the mixture comprises liquid ethane and liquid methane.

FIG. 1 schematically shows a floating structure 70 comprising at least one tank 3, 5 for storage and/or transport of at least one cryogenic liquid LC1, LC2 comprising methane. In the example illustrated, the structure 70 comprises a plurality of tanks 3, 5 comprising the cryogenic liquid LC1, LC2.

The cryogenic liquid LC1, LC2 comprising methane may be liquefied natural gas LC1 or a mixture LC2 of an alkane comprising at least two carbon atoms and being in the liquid state and liquid methane, especially at atmospheric pressure. Preferably, the mixture LC2 has a methane number of less than 70. It is understood that the supply system 1 is configured so that the fuel prepared from the gas resulting from the boil-off of the mixture has a methane number higher than the methane number of the mixture.

In a preferred embodiment, the alkane comprising at least two carbon atoms is chosen from ethane, propane, butane and at least one mixture thereof. Preferably, the mixture consists of liquid ethane and liquid methane

Referring to FIG. 1, the tank(s) 3, 5 contain the cryogenic liquid LC1, LC2 in liquid form L1, L2. Since the thermal insulation of the tanks 3, 5 is not perfect, part of the cryogenic liquid LC1, LC2 boils off. Consequently, the tanks 3, 5 of the structure 70 comprise both cryogenic liquid LC1, LC2 in liquid form L1, L2 and cryogenic liquid LC1, LC2 in gaseous form G1, G2.

The structure 70 comprises at least one propulsion device 9 supplied with a fuel. As an example, the at least one propulsion device 9 may be a propulsion engine of the structure, such as an ME-GI or XDF engine. It is understood that this is only an example embodiment of the present invention and that provision may be made for the installation of different propulsion devices without departing from the context of the present invention.

Referring to FIG. 1, the structure 70 comprises a system 11 for supplying fuel to the propulsion device 9. The supply system 11 comprises a sampling branch 13 for sampling the liquid phase L1, L2 of the cryogenic liquid LC1, LC2 that is contained in at least one tank 3, 5 of the structure 70.

A liquid inlet 131 of the sampling branch 13 is immersed in the liquid phase L1, L2 of the cryogenic liquid LC1, LC2 so as to puncture the liquid phase L1, L2. A gas outlet 133 from the sampling branch 13 is connected to an inlet 903 of the propulsion device 9 to deliver fuel thereto.

The sampling branch 13 comprises a compression member 15 to supply the propulsion device with fuel at an adequate pressure. The sampling branch 13 may comprise a heater-cooler 17 to bring the fuel to an appropriate temperature. The fuel is in gaseous form at the gas outlet 133 of the sampling branch 13. In the case where the cryogenic liquid comprising methane is liquefied natural gas, then the propulsion device 9 will be supplied with liquefied natural gas LC1 in gaseous form. In the event that the cryogenic liquid comprising methane is a mixture of liquid methane and an alkane having at least two carbon atoms and being in the liquid state, then the propulsion device 9 will be supplied with mixture LC2 in gaseous form.

The sampling branch 13 may comprise at least one sampling valve 19 so as to control the puncture of the liquid phase L1, L2 of the cryogenic liquid LC1, LC2 contained in at least one tank 3, 5. In other words, the sampling valve 19 makes it possible to authorize the puncture, to prohibit the puncture and/or to regulate the puncture flow rate of the liquid phase L1, L2 of the cryogenic liquid LC1, LC2. The sampling valve 19 is arranged between the inlet 131 of the sampling branch 13 and an inlet of the heater-cooler 17. The sampling valve 19 may be a three-way valve or two valves as shown in FIG. 1.

In the embodiment illustrated in FIG. 1, the sampling branch 13 comprises several liquid inlets 131, each being immersed in the liquid phase L1, L2 of the cryogenic liquid LC1, LC2 of a different tank 3, 5. The sampling branch 13 also comprises several sampling valves 19 arranged so as to also be able to choose the tank for the puncture of the liquid phase L1, L2 of the cryogenic liquid LC1, LC2. The plurality of sampling valves 19 may also allow regulation of the flow rates of punctured liquid phase L1, L2.

The sampling branch 13 may comprise at least one pump 135 immersed in the liquid phase L1, L2 of the cryogenic liquid LC1, LC2 in order to facilitate the puncture of the liquid phase L1, L2 of the cryogenic liquid LC1, LC2. The pump 135 is arranged at the liquid inlet 131 of the sampling branch 13.

Referring to FIG. 1, the structure 70 comprises at least one consumer 7 of a fuel prepared from a gas contained in the tank(s) 3, 5 of the structure, the gas being the gaseous phase G1, G2 resulting from the boil-off of the cryogenic liquid LC1, LC2 stored and/or transported in the tank(s) 3, 5 of the structure.

As an example, the at least one consumer 7 may be an electric generator of the DFDE (Dual Fuel Diesel Electric) type, that is to say, a gas consumer configured to ensure the electrical supply of the structure 70. It is understood that this is only an example embodiment of the present invention and that provision may be made for the installation of different gas consumers without departing from the context of the present invention.

The structure 70 comprises a supply system 1 to supply fuel to the consumer 7. The supply system 1 comprises at least one gas inlet 101 in fluidic communication with at least one gas outlet 303, 503 from the tank(s) 3, 5 of the structure 70 and a gas outlet 103 in fluidic communication with at least one fuel inlet 701 of the consumer 7.

The supply system 1 comprises a fuel preparation system 45 whereof at least one gas outlet 453 is connected to the consumer 7 to deliver the fuel and a supply branch 21 configured to bring at least a portion of the gas G1, G2 from the tank 3, 5 to an inlet 451 of the preparation system 45.

The supply system 1 comprises a heat exchange module 22 configured to at least partly liquefy the gas resulting from the boil-off of the mixture LC2 contained in at least one of the tanks 3, 5.

The heat exchange module 22 comprises a heat exchanger 23 comprising a first pass 25 constituting the supply branch 21. The first pass 25 is disposed at least at one gas inlet 211 of the supply branch 21. The gas inlet 211 of the supply branch 21 forms part of the gas inlet 101 of the supply system 1. The gas inlet 211 of the supply branch 21 is therefore connected, via a duct, to a gas outlet 303, 503 of at least one of the tanks 3, 5 of the structure 70.

In the embodiment shown in FIG. 1, the supply branch 21 comprises a plurality of gas inlets 211 forming part of a plurality of gas inlets 101 of the supply system 1. The gas inlets 211 of the supply branch 21 are each connected to a gas outlet 303, 503 of a tank 3, 5 of the structure 70.

The supply system 1 comprises a bypass branch 29 of the first pass 25 of the heat exchanger 23. The bypass branch 29 connects an inlet 251 of the first pass 25 and an outlet 253 of the first pass 25. The bypass branch 29 is thus mounted in parallel with the first pass 25 of the heat exchanger 23.

Referring to FIG. 1, the heat exchanger 23 comprises a second pass 27 constituting the supply branch 21. The second pass 27 is connected to the first pass 25 by a connecting portion 215 of the supply branch 21. In other words, an outlet of the first pass 253 is connected to an inlet of the second pass 271 by the connecting portion 215 of the supply branch 21.

The second pass 27 of the heat exchanger 23 is configured to exchange calories with the first pass 25 of the heat exchanger 23.

The connecting portion 215 of the supply branch 21 comprises at least one compression device 31 configured to increase the pressure of a fluid flowing in the connecting portion 215 of the supply branch 21. The compression device is therefore arranged between the outlet 253 of the first pass 25 and the inlet 271 of the second pass 27.

The heat exchange module 22 comprises a thermal heat exchanger 37 comprising a first pass 39 constituting the supply branch 21. The first pass 39 of the thermal heat exchanger 37 is arranged between an outlet 273 of the second pass 27 of the heat exchanger 23 and the inlet 451 of the preparation system 45.

Referring to FIG. 1, the supply system 1 comprises a cooling branch 33 configured to be passed through by a portion of the liquid phase L1, L2 of the cryogenic liquid LC1, LC2 contained in at least one tank 3, 5 of the structure 70. Thus, a portion of the liquid phase L1 of liquefied natural gas LC1 or a portion of liquid L2 of the mixture LC2 is able to flow into the cooling branch 33.

More specifically, a liquid inlet 331 of the cooling branch 33 is immersed in the liquid phase L1, L2 of the cryogenic liquid LC1, LC2 contained in the tank(s) 3, 5 of the structure 70. The liquid inlet 331 of the cooling branch 33 is part of a liquid inlet 105 of the supply system 1. In the embodiment illustrated in FIG. 1, the cooling branch 33 comprises a plurality of liquid inlets 331, each immersed in a tank 3, 5 different from the structure 70.

In FIG. 1, the liquid inlet 331 of the sampling branch 33 is optionally provided with at least one pump 335 immersed in the liquid phase L1, L2 of the cryogenic liquid LC1, LC2 in order to facilitate liquid phase puncture L1, L2 of the cryogenic liquid LC1, LC2.

In an embodiment that is not illustrated, the cooling branch 33 comprises a plurality of puncture valves in order to prohibit, authorize and control the sampling of liquid phase from the tanks of the structure.

The thermal heat exchanger 37 comprises a second pass 41 that constitutes the cooling branch 33. Thus, the cooling branch 33 comprises the second pass 41 of the thermal heat exchanger 37. The second pass 41 of the thermal heat exchanger 37 is configured to exchange calories with the first pass 39 of the thermal heat exchanger 37 in order to at least partially liquefy a gas circulating in the first pass 39 of the thermal heat exchanger 37.

An outlet 413 of the second pass 41 of the thermal heat exchanger 37 is connected to a liquid outlet 333 of the cooling branch 33. The liquid outlet 333 of the cooling branch 33 is connected to a spraying device 58 disposed inside the tank 3, 5. The spraying device 58 is arranged so as to be above the liquid phase contained in the tank 3, 5. The spraying device 58 allows the liquid resulting from the second pass 41 of the thermal heat exchanger 37 to be dispersed in the form of droplets.

In the embodiment of FIG. 1, the outlet 413 of the second pass 41 of the thermal heat exchanger 37 is connected to a plurality of liquid outlets 333 of the cooling branch 33, each liquid outlet 333 being connected to a spraying device 58 contained in a tank 3, 5.

The outlet 413 of the second pass 41 of the thermal heat exchanger 37 is also connected to a discharge duct 57 by means of a connecting duct 56. The discharge duct 57 is described below.

The supply system 1 comprises a distribution device 64 configured to authorize or prohibit a passage of fluid toward the spraying device(s) 58 and/or toward the discharge duct 57.

The distribution device 64 comprises a plurality of control devices 641, 643. A first control device 643 is arranged on the connecting duct 56. The first control device 643 is for example a one-way valve.

The second control device 641 is arranged on the cooling branch 33 between the junction of the cooling branch 33 with the connecting duct 56 and the spraying device 58. The second control device 641 is for example a one-way valve.

The cooling branch 33 comprises a cooling device 35 arranged between the liquid inlet 105 of the supply system 1 and an inlet 411 of the second pass 41 of the thermal heat exchanger 37. In other words, the cooling device 35 is disposed between the liquid inlet 331 of the cooling branch 33 and the inlet 411 of the second pass 41 of the thermal heat exchanger 37.

The cooling device 35 is configured to cool the liquid phase portion L1, L2 of the cryogenic liquid LC1, LC2 circulating in the cooling branch 33. By way of example, the cooling device 35 could alternately cool a portion of the liquid phase L1 of the liquefied natural gas LC1 and a portion of the liquid phase L2 of the mixture LC2.

The supply system 1 comprises a bypass branch 43 of the second pass 41 of the thermal heat exchanger 37. The bypass branch 43 connects an inlet 411 of the second pass 41 of the thermal heat exchanger 37 to an outlet 413 of the second pass 41 of the heat exchanger 37. In other words, the bypass branch 43 is mounted in parallel with the second pass 41 of the thermal heat exchanger.

The supply system 1 comprises a connection channel 330 from the inlet 411 of the second pass 41 of the thermal heat exchanger 37 to a connection point PR0 of the cooling branch 33. The connection point PR0 is arranged on the cooling branch 33 between the second control device 377 of the distribution device 64 and the spraying device 58.

Referring to FIG. 1, the fuel preparation system 45 from the gas at least partially liquefied by the heat exchange module 22 comprises a first phase separator 47, a second phase separator 55 and an expansion device 53.

The first phase separator 47 comprises an inlet 471 connected to the outlet 393 of the first pass 39 of the thermal heat exchanger 37. It is understood in this context that the inlet 471 of the first phase separator 47 is part of the inlet 451 of the preparation system 45.

The first phase separator 47 comprises a gas outlet 473 that forms part of the gas outlet 103 of the supply system 1. The gas outlet 473 of the first phase separator 47 is connected to a fuel inlet 701 of the consumer 7 to deliver the fuel. The connection between the gas outlet 473 of the first phase separator 47 and the consumer 7 is ensured by a connecting duct 49.

It is therefore understood that the connecting duct 49 also ensures the connection between the gas outlet 103 of the supply system 1 and the fuel inlet 701 of the consumer 7. It is also understood that the gas outlet 473 of the first phase separator 47 is part of a gas outlet 453 of the preparation system 45, which in turn is part of the gas outlet 103 of the supply system 1.

The first phase separator 47 comprises a liquid outlet 475 that is connected by a line 51 to an inlet 551 of the second phase separator 55. The expansion device 53 is disposed on the line 51. The line 51 may for example be a duct.

The second phase separator 55 comprises a gas outlet 553 connected, via a duct 59, to a junction point PJ of the supply branch 21. The junction point PJ is arranged between the gas outlet 303, 503 of at least one of the tanks 3, 5 of the structure 70 and an inlet 311 of the compression device 31. In the embodiment illustrated in FIG. 1, the junction point is arranged on the connecting portion 211 of the supply branch 21. The second phase separator 55 comprises a liquid outlet 555 that is in fluidic communication with the tank(s) 3, 5 of the structure 70. In other words, the liquid outlet 555 of the second phase separator 55 is connected inside at least one tank 3, 5 by a discharge duct 57. One end of the discharge duct 57 is immersed in the liquid phase L1, L2 of the cryogenic liquid LC1, LC2 stored and/or transported in the tank 3, 5. In the example shown in FIG. 1, the discharge duct 57 comprises a plurality of ends each immersed in the liquid phase L1, L2 of the cryogenic liquid LC1, LC2.

Referring to FIG. 1, the supply system 1 comprises a bypass branch 61 of at least the preparation system 45. In the embodiment illustrated in FIG. 1, the bypass branch 61 also makes it possible to bypass the heat exchanger 23 and the thermal heat exchanger 37.

The bypass branch 61 is arranged between an outlet 313 of the compression device 31 and a gas outlet 453 of the preparation system 45. In other words, the bypass branch 61 connects the outlet 313 of the compression device 31 and the gas outlet 453 of the preparation system 45. In the embodiment shown in FIG. 1, the compression device 31 comprises a plurality of compression stages 315.

The supply system 1 comprises a fuel heater-cooler 65 arranged between the gas outlet 453 of the preparation system 45 and the gas outlet 103 of the supply system 1 connected to the fuel inlet 701 of the consumer 7. It is therefore understood that, in the embodiment of FIG. 1, the heater-cooler 65 is disposed on the connecting duct 49 between a gas outlet 453 of the preparation system 45 and the fuel inlet 701 of the consumer 7.

The supply system 1 comprises a conversion device 69 configured to alternate between the first configuration and the second configuration of the supply system 1.

The conversion device 69 comprises a first regulation device 231, 233, 235 arranged to control the flow of gas in the first pass 25 of the heat exchanger 23 or in the bypass branch 29. Thus, the first regulation device 231, 233, 235 authorizes, prohibits and/or regulates a passage of fluid in at least part of the supply system 1.

In the example illustrated in FIG. 1, the first regulation device 231, 233, 235 comprises a plurality of one-way valves. A first one-way valve 231 is arranged at the inlet 251 of the first pass 25 of the heat exchanger 23, a second one-way valve 233 is arranged at the outlet 253 of the first pass 25 of the heat exchanger 23 and a third one-way valve 235 is arranged in the bypass branch 29. These one-way valves 231, 233, 235 will make it possible to authorize or prohibit a passage of fluid in the first pass 25 of the heat exchanger 23 and/or in the bypass branch 29. In other words, these one-way valves 231, 233, 235 are configured to assume an open position, a half-open position to regulate the flow or a closed position.

In an embodiment that is not shown, the first regulation device comprises two-way valves arranged at the junctions between the supply branch and the bypass branch.

The conversion device 69 comprises a second regulation device 371, 373, 375, 377 arranged to control the circulation of liquid in the second pass 41 of the thermal heat exchanger 37 and/or in the bypass branch 43 and/or in the connection channel 330. Thus, the second regulation device 371, 373, 375, 377 authorizes, prohibits and/or regulates a passage of fluid in at least part of the supply system 1.

In the example illustrated in FIG. 1, the second regulation device 371, 373, 375, 377 comprises a plurality of one-way valves. A first one-way valve 371 is arranged at the inlet 411 of the second pass 41 of the thermal heat exchanger 37, a second one-way valve 373 is arranged at the outlet 413 of the second pass 41 of the thermal heat exchanger 37, a third one-way valve 375 is arranged in the bypass branch 43, and a fourth one-way valve 377 is arranged in the connection channel 330. The one-way valves of the second regulation device 371, 373, 375, 377 will make it possible to authorize or prohibit a passage of fluid in the first pass 25 of the thermal heat exchanger 37 and/or in the bypass branch 43 and/or a fourth one-way valve 377 is arranged in the connection channel 330. In other words, the one-way valves of the second regulation device 371, 373, 375, 377 are configured to assume an open position, a half-open position to regulate the flow or a closed position.

In an embodiment that is not shown, the second regulation device comprises two-way valves arranged at the junctions between the cooling branch and the bypass branch. The conversion device 69 comprises a third regulation device 611, 613, 615 arranged to control the circulation of liquid in the second pass 27 of the heat exchanger 23 or in the bypass branch 61. Thus, the third regulation device 611, 613, 615 authorizes, prohibits and/or regulates a passage of fluid in at least part of the supply system 1.

In the example illustrated in FIG. 1, third regulation device 611, 613, 615 comprises a plurality of one-way valves. A first one-way valve 611 is arranged at the inlet 271 of the second pass 27 of the heat exchanger 23, a second one-way valve 613 is arranged on the bypass branch 61, and a third one-way valve 615 at the gas outlet 453 of the preparation system 45. The one-way valves of the third regulation device 611, 613, 615 will make it possible to authorize or prohibit a passage of fluid in the second pass 27 of the heat exchanger 23 and/or in the bypass branch 61. In other words, the one-way valves of the third regulation device 611, 613, 615 are configured to assume an open position, a half-open position to regulate the flow or a closed position.

In an embodiment that is not shown, the third regulation device comprises two-way valves or three-way valves arranged at the junctions between the supply branch and the bypass branch and at the junction between the bypass branch and the connecting duct.

FIG. 2 is a representation of the supply system 1 in a first configuration. The tanks 3, 5 of the structure 70 contain a cryogenic liquid LC1, LC2 comprising methane. The first configuration of the supply system 1 is more particularly suitable when the cryogenic liquid LC1 is liquefied natural gas LC1.

In the first configuration of the supply system 1, the first regulation device 231, 233, 235 authorizes the circulation of fluid in the bypass branch 29 and prohibits the passage of fluid in the first pass 25 of the heat exchanger 23.

The second regulation device 371, 373, 375, 377 authorizes the circulation of fluid in the bypass branch 43, prohibits the passage of fluid in the second pass 41 of the thermal heat exchanger 37 and prohibits the passage of fluid in the connection channel 330.

The third regulation device 611, 613, 615 authorizes the circulation of fluid in the bypass branch 61. The third regulation device 611, 613, 615 prohibits the passage of fluid in the first pass 39 of the thermal heat exchanger 37, in the second pass 27 of the heat exchanger 23, and in the preparation system 45.

In this first configuration, the gas G1 resulting from the boil-off of the cryogenic liquid LC1 in liquid form L1 that is contained in the tank(s) 3, 5 of the structure 70 is taken from one of the tanks 3, 5 by the supply branch 21. The gas G1 passes into the bypass branch 29.

Then, the gas G1 is compressed by the compression device 31. The pressure of the gas G1 at the inlet 311 of the compression device 31 is therefore lower than the pressure of the gas G1 at the outlet 313 of the compression device 31.

The compressed gas G1 flows into the bypass branch 61. The compressed gas G1 therefore avoids the heat exchanger 23, the thermal heat exchanger 37 and the preparation system 45.

After passing through the bypass branch 61, the compressed gas G1 flows into the connection branch 49 and passes through the heater-cooler 65, which increases the temperature of the compressed gas G1 before being routed to at least one consumer 7. The compressed gas G1 cannot go into the first phase separator 47 because the third one-way valve 615 of the third regulation device 611, 613, 615 prevents access to it.

In parallel, part of the cryogenic liquid LC1 in liquid form L1 in at least one tank 3, 5 of the structure 70 is sampled. The liquid L1 flows successively in the cooling branch 33, in the cooling device 35, which cools the liquid L1, in the cooling branch 33, in the bypass branch 43, then again in the cooling branch 33.

The distribution device 64 is in a configuration that allows the liquid L1 to flow into the connecting duct 56 and thus reach the discharge duct 57, and which prevents the liquid L1 from flowing toward the spraying device 58.

FIG. 3 shows the supply system 1 in a second configuration. The tanks 3, 5 of the structure 70 contain a cryogenic liquid LC1, LC2 comprising methane. The second configuration of the supply system is more particularly suitable when the cryogenic liquid LC2 is a mixture L2 of liquid methane and an alkane comprising at least two carbon atoms in the liquid state. Preferably, the content of alkane having at least two carbon atoms and in the liquid state is greater than the content of liquid methane in the mixture L2.

In the first configuration of the supply system 1, the first regulation device 231, 233, 235 authorizes the circulation of fluid in the first pass 25 of the heat exchanger 23 and prohibits the passage of fluid in the bypass branch 29.

The second regulation device 371, 373, 375, 377 authorizes the circulation of fluid in the second pass 41 of the thermal heat exchanger 37, prohibits the passage of fluid in the bypass branch 43, and prohibits the passage of fluid in the connection channel 330.

The third regulation device 611, 613, 615 authorizes the circulation of fluid in the first pass 39 of the thermal heat exchanger 37, in the second pass 27 of the heat exchanger 23, and in the preparation system 45. The third regulation device 611, 613, 615 prohibits the passage of fluid in the bypass branch 61.

In this second configuration, the gas G2 resulting from the boil-off of the cryogenic liquid LC2 in liquid form L2 that is contained in the tank(s) 3, 5 of the structure 70 is taken from one of the tanks 3, 5 by the supply branch 21.

The gas G2 flows in the first pass 25 of the heat exchanger 23 by exchanging calories with the second pass 27 of the heat exchanger 23. At the outlet 253 of the first pass 25 of the heat exchanger 23, the temperature of the gas G2 has increased.

The heated gas G2 is then compressed by the compression device 31. Thus, the gas G2 has a pressure at the outlet 313 of the compression device 31 that is suitable for entering the preparation system 45. By way of example, in this embodiment, the pressure is 6.5 bars at the outlet 313 of the compression device 31. The temperature of the compressed gas G2 remains substantially identical to the temperature of the gas G2 at the outlet of the first pass 25 of the heat exchanger 23.

The gas G2 then flows into the second pass 27 of the heat exchanger 23 to yield calories by exchanging these calories with the first pass 25 of the heat exchanger 23. Thus, the temperature of the gas G2 is lowered at the outlet of the second pass 27 of the heat exchanger 23.

In the heat exchanger 23, the flow of compressed gas G2 in the second pass 27 is oriented in a direction opposite the gas flow G1 in the first pass 25.

Then, the gas G2 flows in the first pass 39 of the thermal heat exchanger 37. The gas G2 again yields calories by exchanging calories at the second pass 41 of the thermal heat exchanger 37. The gas G2 is then at least partly liquefied.

At the outlet 393 of the first pass 39 of the thermal heat exchanger 37, there is a mixture of gas and liquid whose compositions are different. The fuel preparation system 45 will allow the fuel to be isolated from this mixture.

The mixture passes through the first phase separator 47. The gaseous phase, which is the fuel for the consumer 7, and the liquid phase of the mixture are separated. The gaseous phase contained in the first phase separator 47 flows into the connection branch 49 to supply the consumer via the heater-cooler 65.

The liquid phase of the mixture is sent to the second phase separator 55 via the line 51, which connects the liquid outlet 475 of the first phase separator 47 to the inlet 551 of the second phase separator 55.

Passing through the line 51, the liquid phase of the mixture is expanded by the expansion device 53. A portion of the liquid phase evaporates, creating another mixture composed of a liquid phase and a gaseous phase that will be decanted in the second phase separator 55.

The liquid phase contained in the second phase separator 55 is returned to at least one of the tanks 3, 5 of the structure 70. The gaseous phase contained in the second phase separator 55 is returned to the supply branch 21 at the junction point PJ that is between the outlet 253 of the first pass 25 of the heat exchanger 23 and the inlet 311 of the compression device 31.

In parallel, part of the cryogenic liquid LC1 in liquid form L1 in at least one tank 3, 5 of the structure 70 is sampled. The liquid L1 flows into the cooling branch 33 and passes successively into the cooling device 35 and into the second pass 41 of the thermal heat exchanger 37 to finally be dispersed in one of the tanks 3, 5 by the spraying device 58.

Thus, in the configuration of the first embodiment illustrated in FIG. 3, the distribution device 64 is in a configuration that prevents the liquid L1 from flowing into the connecting duct 56 and that allows the flow of the liquid L1 toward the spraying device 58.

The flow of the cryogenic liquid in liquid form in the second pass 41 of the thermal heat exchanger 37 makes it possible to liquefy, at least in part, the gas that passes at the same time in the first pass 39 of the thermal heat exchanger 37.

In the thermal heat exchanger 37, the flow of the gas G2 in the first pass 39 is oriented in a direction opposite the flow of the liquid G2 in the second pass 41 of the thermal heat exchanger 37.

FIG. 4 illustrates a second embodiment of the fuel supply system of the consumer(s). The supply system is particular in that the heat exchange module comprises a calorie exchanger so as to take advantage of the cold from the liquid taken from at least one of the tanks of the structure to supply the propulsion device. The fuel is prepared from liquefied natural gas or a mixture of liquid methane and an alkane comprising at least two carbon atoms and in the liquid state, especially at atmospheric pressure, the mixture being contained in at least one tank of the floating structure. Preferably, the alkane comprising at least two carbon atoms is chosen from ethane, propane, butane and at least one mixture thereof.

Identical elements between the third embodiment and the other embodiments are designated by the same references in the figures. For the description of the identical elements, reference may be made to the description of the preceding embodiments.

Referring to FIG. 4, the heat exchange module 22 of the supply system 1 comprises a calorie exchanger 91 that comprises a first pass 93 constituting the supply branch 21 and a second pass 95 constituting the sampling branch 13.

The first pass 93 of the calorie exchanger 91 is arranged between the outlet 273 of the second pass 27 of the heat exchanger 23 and the inlet 391 of the first pass 39 of the thermal heat exchanger 37. The second pass 95 of the calorie exchanger 91 is arranged between the liquid inlet 131 of the sampling branch 13 and the compression member 15. The first pass 93 of the calorie exchanger 91 is configured to exchange calories with the second pass 95 of the calorie exchanger 91.

When the liquid phase L1, L2 of the cryogenic liquid LC1, LC2 is taken from one of the tanks 3, 5 of the structure 70 to supply the propulsion device 9, the liquid phase L1, L2 of the cryogenic liquid LC1, LC2 flows into the sampling branch 13 and passes through the second pass 95 of the calorie exchanger 91, then into the compression member 15.

Concomitantly, the gaseous phase G2 of the mixture LC2 of liquid methane and an alkane comprising at least two carbon atoms in the liquid state is taken from the tank 3, 5. Thus, the mixture LC2 flows into the supply branch 21 to prepare the fuel for the consumer(s) 7. More particularly, the mixture LC2 passes successively through the second pass 27 of the heat exchanger 23, through the first pass 93 of the calorie exchanger 91 and through the first pass 39 of the thermal heat exchanger 37 before entering the preparation system 45.

In this context, the flow of liquefied natural gas or of the mixture in the second pass 95 of the calorie exchanger 91 occurs in a direction having the same sense as that of the flow of the mixture in the first pass 93 of the calorie exchanger 91. Thus, the mixture is colder at an outlet 933 of the first pass 93 than at an inlet 931 of the first pass 91 of the calorie exchanger 91. In addition, the liquefied natural gas LC1 or the mixture LC2 is hotter at an outlet 953 of the second pass 95 than at an inlet 951 of the second pass 95 of the calorie exchanger 91. It is therefore understood that it is possible to have, on the same structure, a tank comprising liquefied natural gas LC1 that is used to supply the propulsion device 9 passing through the second pass 95 of the calorie exchanger 91 and a plurality of tanks comprising the mixture LC2 whose boil-off will be used to prepare the fuel for the consumer(s) 7 by passing through the first pass 93 of the calorie exchanger.

As the second embodiment is shown in FIG. 4, the preparation system 45 comprises the first phase separator 47 and the expansion device 53 described in the first embodiment. More particularly, the preparation system 45 here comprises only the first phase separator 47 and the expansion device 53. The liquid outlet 475 of the first phase separator 47 is in fluidic communication with at least one of the tanks 3, 5 of the structure 70 via the line 51 that is connected to the discharge duct 57. The expansion device 53 is arranged on the line 51 that connects the liquid outlet 475 of the first phase separator 47 to the discharge duct 57.

In this second embodiment, and optionally, the supply system 1 comprises a control device 401 that is configured to raise the temperature of the fluid at the outlet 393 of the first pass 39 of the thermal heat exchanger 37 and consequently adjusts the fluid flow at the inlet 411 of the second pass 41 of the thermal heat exchanger 37 via the conversion device 69, more particularly via the second regulation device 371, 373, 375, 377. Thus, optimal liquefaction of the fluid is ensured at the outlet 393 of the first pass 39 of the thermal heat exchanger 37.

FIG. 5 illustrates a third embodiment of the fuel supply system of the consumer(s). The supply system is particular in that it is configured to supply fuel to the propulsion device in addition to the consumer(s). The fuel is prepared from liquefied natural gas or a mixture of liquid methane and an alkane having at least two carbon atoms and being in the liquid state, the mixture being contained in at least one tank of the floating structure. Preferably, the alkane having at least two carbon atoms is chosen from ethane, propane, butane and at least one mixture thereof.

Identical elements between the third embodiment and the other embodiments are designated by the same references in the figures. For the description of the identical elements, reference may be made to the description of the preceding embodiments.

Referring to FIG. 5, the supply system 1 comprises an attachment branch 319 that connects a first attachment point PR1 arranged on the connecting portion 215 of the supply branch 21 and a second attachment point PR2 arranged on the sampling branch 13.

The first attachment point PR1 is arranged on the supply branch 21 between a gas inlet 211 of the supply branch 21 and the inlet 391 of the first pass 39 of the thermal heat exchanger 37. More specifically in FIG. 5, the first attachment point PR1 is disposed between the outlet 253 of the first pass 25 of the heat exchanger 23 and the inlet 271 of the second pass 27 of the heat exchanger 23.

The second attachment point PR2 is in turn disposed between an outlet of the heater-cooler 17 and the gas outlet 133 from the sampling branch 13, that is to say, disposed between the outlet of the heater-cooler 17 and the fuel inlet 901 of the propulsion device 9.

The compression device 31 is a compressor comprising a plurality of compression stages 315 configured to compress the fluid flowing in the supply branch 21. A first part of the compression stages 315 is arranged on the connecting portion 215 of the supply branch 21 and a second part of the compression stages 315 is arranged on the attachment branch 319.

A low-pressure outlet 313 of the compression device 31 is arranged between the first part of the compression stages 315 and the second part of the compression stages 315 of the compression device 31. The low-pressure outlet 313 corresponds to the first connection point PR1. At least part of the fluid flowing at the low-pressure outlet 313 of the compression device 31 after having passed through the first part of the compression stages 315 has a pressure suitable for the preparation system 45. A high-pressure outlet 317 of the compression device 31 is arranged on the connection branch 313 and corresponds to an outlet of the last compression stage 315 of the second part of the compression stages 315 arranged on the attachment branch 319. Thus, another part of the fluid having passed through the first part of the compression stages flows into the connection branch 319 and passes through the second part of the compression stages 315. The fluid has a suitable pressure for the propulsion device 9 at the high-pressure outlet 317 of the compression device 31. By way of example, the fluid has a pressure of between 30 bars and 40 bars at the high-pressure outlet 317 of the compression device 315.

The supply system 1 comprises a sharing device 66 configured to prohibit or allow a flow of fluid toward the second pass 27 of the heat exchanger 23 and configured to prohibit or allow a flow of fluid in the connection branch 319.

The sharing device 66 comprises a plurality of dispensing devices 661, 663. A first dispensing device 661 is arranged on the connecting portion 215 of the supply branch 21 between the first connection point PR1 and the inlet of the second pass 27 of the heat exchanger 23. The first dispensing device 661 is for example a one-way valve. The second dispensing device 663 is arranged on the connection branch 319 between the high-pressure outlet 315 of the compression device 31 and the second connection point PR2. The second dispensing device 663 is for example a one-way valve.

In the third embodiment, the sharing device 66 is in a configuration where the fluid is allowed to flow to the second pass 27 of the thermal heat exchanger 25 after having passed through the first part of the compression stages 315 of the compression device 31. In contrast, in this configuration, the sharing device 66 prohibits the flow of fluid in the connection branch 319.

As illustrated in FIG. 5, the third embodiment uses the preparation system 45 of the second embodiment, that is to say, with only the first phase separator 47 and the expansion device 53.

FIG. 6 illustrates a fourth embodiment of the fuel supply system of the consumer(s). The supply system is particular in that it is configured to supply fuel to the propulsion device in addition to the consumer(s). The fuel is prepared from liquefied natural gas or from a mixture contained in at least one tank of the floating structure, the mixture of liquid methane and an alkane comprising at least two carbon atoms and occurring at the liquid state. Preferably, the alkane comprising at least two carbon atoms is chosen from ethane, propane, butane and at least one mixture thereof.

Identical elements between the fourth embodiment and the other embodiments are designated by the same references in the figures. For the description of the identical elements, reference may be made to the description of the preceding embodiments.

Referring to FIG. 6, the supply system 1 comprises an attachment branch 319 that connects a first attachment point PR1 arranged on the connecting portion 215 of the supply branch 21 and a second attachment point PR2 arranged on the sampling branch 13.

More specifically, the first attachment point PR1 is disposed between the outlet 253 of the first pass 25 of the heat exchanger 23 and the inlet 271 of the second pass 27 of the heat exchanger 23. The second attachment point PR2 is in turn disposed between an outlet of the heater-cooler 17 and the gas outlet 133 from the sampling branch 13, that is to say, disposed between the outlet of the heater-cooler 17 and the fuel inlet 901 of the propulsion device 9.

When the fluid flows in the supply branch 21, it passes through the first pass 25 of the heat exchanger 23, then the compression device 31 and then the second pass 27 of the heat exchanger 23 or the connection branch 319. At the outlet 313 of the compression device 31, the fluid has an adequate pressure to be used by the propulsion device 9. In contrast, this pressure is too high for the fluid to be used by the preparation system 45.

Consequently, the supply system 1 comprises an expansion device 277 arranged on the supply branch 21 between the outlet 273 of the second pass 27 of the heat exchanger 23 and the inlet 391 of the first pass 39 of the heat exchanger 37. Thus, when the fluid flows from the outlet 273 of the second pass 27 of the heat exchanger 23 and the inlet 391 of the first pass 39 of the thermal heat exchanger 37, it passes through the expansion device 277. The pressure of the fluid then drops so that it can be used by the preparation system 45. By way of example, the pressure of the fluid goes from around 40 bars at the inlet of the expansion device 277 to around 6.5 bars at the outlet from the expansion device 277.

The supply system 1 comprises the sharing device 66 described for the framework of the third embodiment. The sharing device 66 is configured to prohibit or allow a flow of fluid toward the second pass 27 of the heat exchanger 23 and is configured to prohibit or allow a flow of fluid in the connection branch 319.

The first dispensing device 661 is arranged on the connecting portion 215 of the supply branch 21 between the first connection point PR1 and the inlet of the second pass 27 of the heat exchanger 23. The first dispensing device 661 is for example a one-way valve.

The second dispensing device 663 is arranged on the connection branch 319 between the first connection point PR1 and the second connection point PR2. The second dispensing device 663 is for example a one-way valve.

In the fourth embodiment, the sharing device 66 is in a configuration where the fluid is allowed to flow to the second pass 27 of the heat exchanger 23 after having passed through the compression device 31 and allowed to flow in the connection branch 319. Thus, the supply system 1 allows fuel to be supplied to the propulsion device 9 and the consumer(s) 7 at the same time. In a variant of the fourth embodiment, the sharing device 66 prohibits the flow of fluid in the connection branch 319. In another variant of the fourth embodiment, the sharing device 66 prevents the flow of fluid toward the inlet 271 of the second branch 27 of the heat exchanger 23.

As illustrated in FIG. 6, the fourth embodiment repeats the preparation system 45 of the second embodiment.

Referring to FIG. 7, a cutaway view of a floating structure 70 shows a sealed and thermally insulated tank 3, 5 of generally prismatic shape mounted in a double hull 72 of the floating structure 70, which may be a ship or a floating platform. A wall of the tank 3, 5 comprises a primary sealed barrier that is intended to be in contact with the cryogenic liquid contained in the tank 3, 5, a secondary sealed barrier that is arranged between the primary sealed barrier and the double hull 72 of the vessel, and two thermally insulating barriers that are arranged between the primary sealed barrier and the secondary sealed barrier and between the secondary sealed barrier and the double hull 72, respectively. In a simplified version, the floating structure 70 comprises a simple hull.

Loading/unloading pipes 73 that are arranged on an upper deck of the floating structure 70 may be connected by means of suitable connectors to a maritime or port terminal in order to transfer a cryogenic liquid cargo from or to the tank 3, 5.

FIG. 7 shows an example of a maritime terminal comprising a loading and/or unloading station 75, an underwater duct 76 and an onshore facility 77. The loading and/or unloading station 75 is a fixed offshore facility comprising a moving arm 74 and a tower 78 that supports the moving arm 74. The moving arm 74 carries a bundle of insulated flexible hoses 79 that can be connected to the loading/unloading pipes 73. The moving arm 74 is adjustable and adapts to all floating structure templates 70. A connecting duct, not shown, extends inside the tower 78. The loading and/or unloading station 75 allows the loading and/or unloading of the floating structure 70 from or to the onshore facility 77. The latter comprises cryogenic liquid storage tanks 80 and connecting ducts 81 that are connected by the underwater duct 76 to the loading and unloading station 75. The underwater duct 76 allows the transfer of the cryogenic liquid between the loading or unloading station 75 and the onshore facility 77 over a great distance, for example 5 km, which allows the floating structure 70 to be kept at a great distance from the coast during loading and/or unloading operations.

In order to generate the pressure necessary for the transfer of the cryogenic liquid, pumps on board the floating structure 70 and/or pumps fitted to the onshore facility 77 and/or pumps fitted to the loading and unloading station 75 are used.

The examples have been described for a floating structure; however, they are also applicable to an onshore structure. Moreover, the invention is not limited to the use of liquefied natural gas or to a mixture of liquid methane and an alkane comprising at least two carbon atoms and being in the liquid state.

It is also understood from the above description that the preparation system can assume at least two configurations, including a first configuration with a single phase separator as described in FIG. 4 to 6 or a second configuration with two phase separators in cascade, called a first phase separator and a second phase separator, as described in FIG. 1 to 3

Of course, the invention is not limited to the examples that have just been described, and numerous modifications can be made to these examples without departing from the scope of the invention. Thus, technical features of the various embodiments can be combined together without departing from the scope of the invention. For example, the temperature control device can be implemented in the first embodiment or the preparation system of the first embodiment can be used in the other embodiments.

1. A floating or onshore structure comprising at least one tank in which is contained liquefied natural gas or a mixture of liquid methane and an alkane comprising at least two carbon atoms and being in the liquid state, at least one consumer, at least one supply system for supplying a fuel to the consumer in a first configuration, the fuel being prepared from a gas resulting from boil-off of the liquefied natural gas contained in the tank, and for supplying the fuel to the consumer in a second configuration, the fuel being prepared from a gas resulting from the boil-off of the mixture contained in the tank, the supply system comprising a conversion device configured to alternate between the first configuration and the second configuration of the supply system, the supply system comprising a heat exchange module configured to at least partially liquefy the gas resulting from the boil-off of the mixture contained in the tank and a fuel preparation system from the at least partly liquefied gas, the fuel being prepared from the at least partly liquefied gas having a methane number greater than a methane number of the mixture.

2. The structure according to claim 1, wherein the fuel preparation system comprises at least one gas outlet connected to the consumer to deliver the fuel, a supply branch configured to supply at least a portion of the gas resulting from the boil-off of the mixture from the tank to an inlet of the preparation system, and the heat exchange module comprises at least one thermal heat exchanger comprising a first pass constituting the supply branch and arranged between a gas inlet of the supply system and the inlet of the preparation system, a cooling branch configured to be passed through by the liquefied natural gas or the mixture, the cooling branch comprising a second pass of the thermal heat exchanger, the second pass of the thermal heat exchanger being configured to exchange calories with the first pass of the thermal heat exchanger in order to at least partially liquefy the gas circulating in the first pass of the thermal heat exchanger.

3. The structure according to claim 2, wherein the heat exchange module comprises at least one heat exchanger comprising a first pass constituting the supply branch and disposed between the gas inlet of the supply system and an inlet of the first pass of the thermal heat exchanger, said gas inlet being connected to a gas outlet of the tank, the heat exchanger comprising a second pass constituting the supply branch and connected to the first pass by a connecting portion of the supply branch, the connecting portion comprising at least one compression device.

4. The structure according to claim 3, wherein the heat exchange module comprises a calorie exchanger comprising a first pass constituting the supply branch and arranged between an outlet of the second pass of the heat exchanger and an inlet of the first pass of the thermal heat exchanger, the calorie exchanger comprising a second pass constituting a sampling branch that is configured to supply at least a portion of the liquefied natural gas or of the mixture from a tank to a fuel inlet of a propulsion device of the structure, the first pass of the calorie exchanger being configured to exchange calories with the second pass of the calorie exchanger.

5. The structure according to claim 3, wherein the supply system comprises a bypass branch of the first pass of the heat exchanger, the bypass branch connecting an inlet of the first pass of the heat exchanger and an outlet of the first pass of the heat exchanger.

6. The structure according to claim 5, wherein the conversion device comprises a plurality of regulation devices disposed at least in part in the supply branch, the plurality of regulation devices comprising a first regulation device arranged to control a flow of gas in the first pass of the heat exchanger and/or in the bypass branch.

7. The structure according to claim 2, wherein the supply system comprises a bypass branch of the second pass of the thermal heat exchanger, the bypass branch connecting an inlet of the second pass of the thermal heat exchanger to an outlet of the second pass of the thermal heat exchanger.

8. The structure according to claim 7, wherein the conversion device comprises a plurality of regulation devices arranged at least in part in the cooling branch, the plurality of regulation devices comprising at least a second regulation device arranged to control circulation of liquid in the second pass of the thermal heat exchanger or into the bypass branch.

9. The structure according to claim 3, wherein the supply system comprises a bypass branch of at least the preparation system, the bypass branch being disposed between an outlet of the compression device and a gas outlet of the preparation system.

10. The structure according to claim 9, wherein the conversion device comprises a plurality of regulation devices arranged at least in part in the bypass branch and/or in the supply branch, the plurality of regulation devices comprising a third regulation device arranged to control circulation of the liquid in the second pass of the heat exchanger or in the bypass branch.

11. The structure according to claim 3, wherein the preparation system comprises a first phase separator, a second phase separator and an expansion device disposed on a line connecting a liquid outlet of the first phase separator to an inlet of the second phase separator, an inlet of the first phase separator being connected to the heat exchange module, at least one gas outlet of the first phase separator being connected to the consumer to deliver the fuel, the supply system being configured to place a liquid outlet of the second phase separator in fluidic communication with at least one tank.

12. The structure according to claim 11, wherein a gas outlet of the second phase separator is connected to a junction point of the supply branch arranged between a gas outlet of the tank and an inlet of the compression device.

13. The structure according to claim 2, wherein a flow of liquefied natural gas or of the mixture in the first pass of the thermal heat exchanger is oriented in a direction opposite a flow of liquefied natural gas or of the mixture in the second pass of the thermal heat exchanger.

14. The structure according to claim 3, wherein a flow of liquefied natural gas or of the mixture in the first pass of the heat exchanger is oriented in a direction opposite a flow of liquefied natural gas or of the mixture in the second pass of the heat exchanger.

15. The structure according to claim 4, wherein a flow of liquefied natural gas or of the mixture in the first pass of the calorie exchanger is oriented in a same direction as a flow of liquefied natural gas or of the mixture in the second pass of the calorie exchanger.

16. A transfer system for a cryogenic liquid, the system comprising a floating or onshore structure according to claim 1, insulated pipes arranged so as to connect the tank installed in the floating structure to a floating or onshore storage facility and a pump for driving a flow of cryogenic liquid through the insulated pipes from or to the floating or onshore storage facility to or from the tank of the structure.

17. A method for loading or unloading a floating structure according to claim 1, during which cryogenic liquid is conveyed through insulated pipes from or to a floating or onshore storage facility to or from the tank of the structure.

18. A method for preparing a fuel from a gas resulting from the boil-off of a cryogenic liquid comprising at least methane and stored in at least one tank, the fuel being prepared by a supply system for supplying a structure, the structure being a structure according to ene claim 2, in which a flow of gas takes place at least in the supply branch by passing through the first pass of the thermal heat exchanger, then the preparation system.

19. A method for preparing a fuel from a gas resulting from the boil-off of a cryogenic liquid comprising at least methane, the fuel being prepared by a supply system for supplying a structure, the structure being a structure according to claim 9, a flow of gas takes place at least in the supply branch via the compression device, then in the bypass branch.
